(19) United States
(12) Patent Application Publication
(10) Pub. No.: US 2026/0329489 A1
(43) Pub. Date: Oct. 22, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Hiroaki Morimoto, Kanagawa (JP)

(21) Appl. No.: 19/639,459

(22) Filed: Apr. 6, 2026

(30) Foreign Application Priority Data
Apr. 21, 2025 (JP) 2025-069484

(51) Int. Cl. G06F 3/12

(52) U.S. Cl. CPC G06F 3/1207; G06F 3/121; G06F 3/1234; G06F 3/1259; G06F 3/1287

(57) ABSTRACT

An object is to notify a user of detailed information occurring in a printing apparatus. A technology of the present disclosure obtains second information from a printing apparatus in accordance with a predetermined operation performed on a predetermined notification executed based on the first information which is obtained from the printing apparatus in accordance with IPP (Internet Printing Protocol), the second information containing at least information which is not contained in the first information. Then, a display device is caused, based on the obtained second information, to display information on the printing apparatus, the information on the printing apparatus corresponding to a type of the printing apparatus.

### BACKGROUND

### Field of the Technology

The present disclosure relates to a technology for performing display control of information on a printing apparatus.

### Description of the Related Art

In recent years, in Windows (registered trademark), a standard driver which can be used in common in printing apparatuses provided by a plurality of vendors has been provided. Such an OS-standard driver (hereinafter, referred to also as "OS-standard print software") is included in a package of the OS, and can be used by connecting a host computer in which the OS is installed with any printing apparatus.

Extension applications which extend the functions of such OS-standard print software have been known. Japanese Patent Laid-Open No. 2016-170631 discloses a technology for extending a function of making a notification of an error status of a printer by providing an extension application.

### SUMMARY

Depending on the kinds of extension applications, there is case where information which can be obtained by a mechanism of an OS-standard print software is limited, and detailed information cannot be provided to a user. An object of the present disclosure is to make a notification of detailed information occurring in a printing apparatus.

A non-transitory computer readable storage medium storing a program for causing a computer connected to a printing apparatus to execute the following processing:
obtaining second information from the printing apparatus in accordance with a predetermined operation performed on a predetermined notification executed based on first information which is obtained from the printing apparatus in accordance with IPP (Internet Printing Protocol), the second information containing at least information which is not contained in the first information; and
causing, based on the obtained second information, a display device to display information on the printing apparatus, the information on the printing apparatus corresponding to a type of the printing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system;

FIGS. 2A and 2B are block diagrams showing examples of system configurations of the present invention;

FIG. 3 is a diagram showing a processing flow of a printing apparatus monitoring unit;

FIG. 4 is an example of display of a toast to be displayed in a case where an error is occurring in a printing apparatus;

FIG. 5 is a diagram showing a processing flow of a management information display unit;

FIG. 6 is a diagram showing an example of display of a GUI to be subjected to display control by the management information display unit;

FIG. 7 is a diagram showing a processing flow of a management information display unit;

FIG. 8 is a diagram showing an example of display of a GUI to be subjected to display control by the management information display unit;

FIG. 9 is a diagram showing an example of a toast notification;

FIG. 10A is a diagram showing an example of a screen configuration of a GUI;

FIG. 10B is a diagram showing an example of a screen configuration of a GUI;

FIG. 10C is a diagram showing an example of a screen configuration of a GUI;

FIG. 11 is a diagram showing an example of a message list;

FIG. 12 is a diagram showing an example of a message list;

FIG. 13 is a diagram showing an example of a message list;

FIGS. 14A and 14B are diagrams for explaining an ink information display section; and

FIGS. 15A and 15B are diagrams for explaining a maintenance cartridge information display section.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

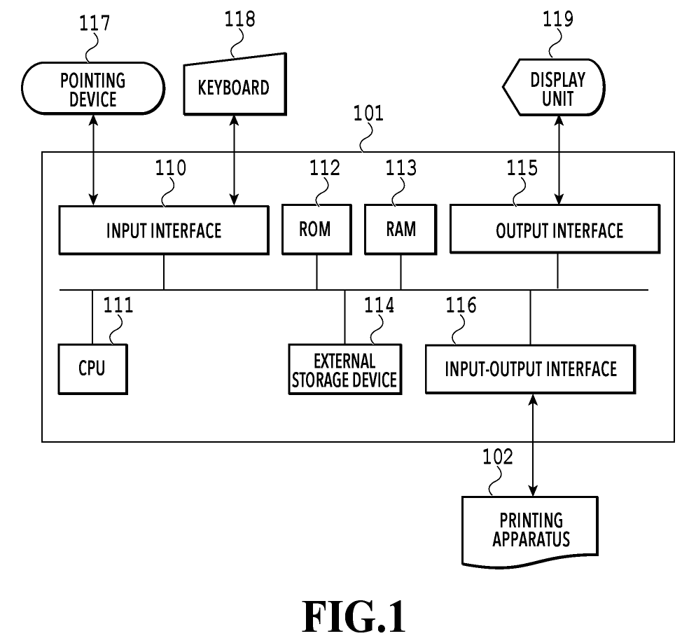

A hardware configuration of a printing system of the present embodiment will be described with reference to FIG. 1. In the present drawing, a host computer 101 is an example of an information processing apparatus, and includes an input interface 110, a CPU 111, a ROM 112, a RAM 113, an external storage device 114, an output interface 115, and an input-output interface 116. In addition, to the input interface 110, an input device such as a keyboard 118 or a pointing device 117 is connected. To the output interface 115, a display device such as a display unit 119 is connected.

In the ROM 112, an initialization program is stored. In the external storage device 114, an application program group, an OS, a print data generating software (OS-standard print software) which is an OS-standard driver, and various other pieces of data are stored. The RAM 113 is used as a work memory or the like in executing various programs stored in the external storage device 114.

Note that in the present embodiment, functions in the host computer 101, which will be described later, and processing according to flowcharts which will be described later, are implemented by the CPU 111 executing the program stored in the ROM 112. A printing apparatus 102 is connected to the host computer 101 via the input-output interface 116. In the printing system shown in FIG. 1, the host computer 101 and the printing apparatus 102 are separate apparatuses; however, these may be configured as a single information processing apparatus. Note that the printing apparatus 102 will be described as a printer of an inkjet method configured to print by ejecting an ink onto a sheet surface as an example, but may be a printer of another method (for example, an electrophotographic method). In addition, the host computer 101 may be a desktop computer, a smartphone, a laptop computer, or the like.

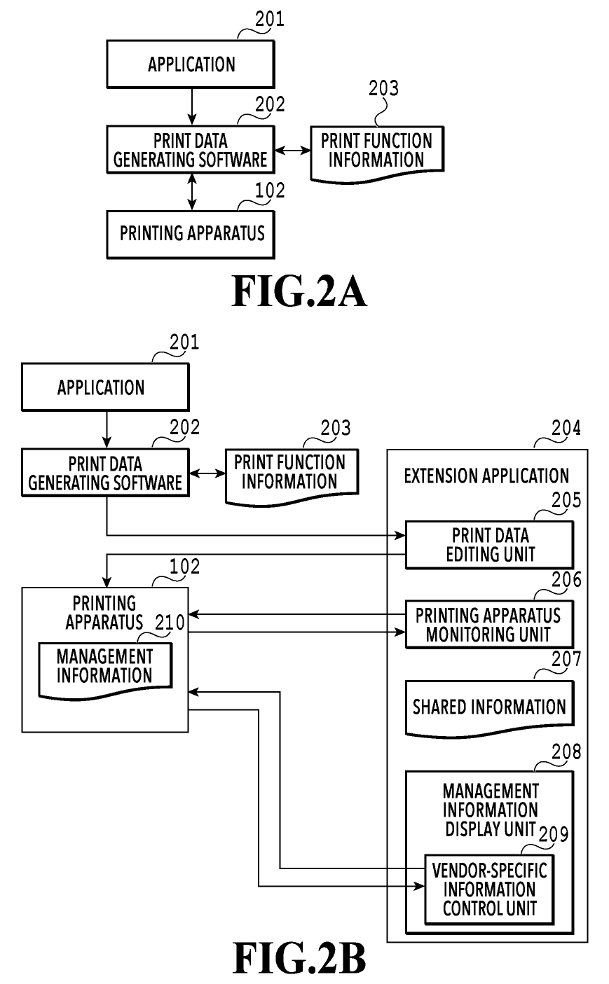

FIGS. 2A and 2B are diagrams schematically showing software configurations of printing systems. Here, a printing system using the host computer 101 having, as an OS, Windows (registered trademark) 10 of Microsoft (registered trademark) will be described as a premise. FIG. 2A is a diagram schematically showing a software configuration of a conventional printing system, as Comparative Example, which does not use an extension application as described in the present embodiment. FIG. 2B is a diagram schematically showing a software configuration in a case where an extension application 204 and print data generating software 202 as well as the printing apparatus 102 are associated with one another according to the present embodiment. First, FIG. 2A will be described.

An application 201 is software for generating contents to be printed, and corresponds to, for example, a drawing application such as a document generating application or a spreadsheet application. Upon receipt of a print request from a user, the application 201 issues a print instruction to the OS (not shown). The print instruction contains print setting information for issuing an operation instruction to the print data generating software 202 or the printing apparatus 102. The print setting information is also referred to as "PrintTicket". The OS generates intermediate data (also referred to as input data) based on the print instruction issued by the application 201, and outputs the intermediate data to the print data generating software 202. In addition, the application 201 can perform display control of a print setting screen provided by the print data generating software 202 or the OS. The print setting screen is configured to display settable print functions and set values of the print functions in accordance with print setting capability information determined by the print data generating software 202.

The print data generating software 202 converts the intermediate data outputted from the OS to print data which can be interpreted by the printing apparatus 102, and transmits the print data to the printing apparatus 102. The print data contains drawing data which is information of a picture (image) to be formed on a sheet surface, and print setting attribute information which is generated based on print setting information set by the user. The print setting information is generated based on a print setting operation by the user via the print setting screen. In addition, the print data generating software 202 determines the print setting capability information based on print function information 203. The print setting capability information is also referred to as "PrintCapabilities". In the print function information 203, all settable print functions and set values of the print functions, as well as an exclusive relationship between the set values are described. The print function information 203 is also referred to as "PDC (Print Device Capabilities)". The print function information 203 is contained in a configuration file of the print data generating software 202, and is placed as an unchangeable file in the external storage device 114.

The printing apparatus 102 prints a sheet based on the print data transmitted from the print data generating software 202. At this time, the printing apparatus 102 forms, on the sheet, an image indicated by the drawing data contained in the print data, in an operation according to the print setting attribute information contained in the print data. The print setting attribute information contains a print quality (image quality priority, speed priority, or the like), designation of double-sided printing, and the like. For example, in a case where the print setting attribute information contains the designation of double-sided printing, the printing apparatus 102 executes double-sided printing.

Incidentally, data which the application 201 outputs for printing includes data in Graphic Device Interface format (GDI data) and data in XML Paper Specification format (XPS data). In the case of using the IPP Class Driver as the print data generating software 202, the OS converts GDI data to XPS data, and passes the XPS data obtained by the conversion to the print data generating software 202. The IPP Class Driver is a printer driver which executes print processing in accordance with specifications of a standard print protocol called IPP (Internet Printing Protocol), which is included in Windows (registered trademark) 10. This IPP Class Driver is not a printer driver for a specific printing apparatus 102, but is a printer driver which can be used in common in printing apparatuses of a plurality of different types. Then, the IPP Class Driver obtains capability information on the connected printing apparatus 102, and generates the aforementioned print function information 203 based on the information such that the user can designate print functions supported by the connected printing apparatus 102. Note that the print function information 203 can be dynamically generated by the print data generating software 202. For example, the print data generating software 202 or the OS can be configured to obtain, from the printing apparatus 102, information of functions which can be designated in the printing apparatus 102, and generate the print function information 203 in accordance with the obtained function information. Such configuration allows the print data generating software 202 to be configured such that the user can designate print functions usable in each printing apparatus 102 in accordance with the connected printing apparatuses 102. That is, the print data generating software 202 can be configured such that the user can designate print functions usable in the connected printing apparatuses even in a case where printing apparatuses having different functions or printing apparatuses developed by different vendors are connected.

Next, FIG. 2B will be described. Note that portions which are not particularly mentioned have the same configurations as in FIG. 2A. The extension application 204 is software which is not included in the OS in advance, and is operated by the control of the OS. The user can install the extension application 204 by operating the host computer 101 to download the extension application 204 from a server, which is not shown, via a network. In addition, in a case where the printing apparatus 102 is connected to the host computer 101, the OS obtains device identification information from the printing apparatus 102. The OS may obtain and install the extension application 204 corresponding to the obtained device identification information from a server, which is not shown, via a network.

Note that the print data generating software 202 and the extension application 204 are sometimes updated to an upgraded version, but this update processing may be executed at different timings. That is, the timing at which the print data generating software 202 is obtained by the host computer 101 and the timing at which the extension application 204 is obtained by the host computer 101 may be different from each other. In addition, a trigger by which the print data generating software 202 is obtained by the host computer 101 and a trigger by which the extension application 204 is obtained by the host computer 101 may also be different from each other. Note that in a case where the extension application 204 is installed, the OS associates the extension application 204 with the print data generating software 202 and the printing apparatus 102.

The extension application 204 described in the present embodiment includes a print data editing unit 205, a printing apparatus monitoring unit 206, shared information 207, and a management information display unit 208. The print data editing unit 205 edits print data generated by the print data generating software 202, and passes the edited print data to the OS. The printing apparatus monitoring unit 206 monitors whether an error is occurring in the printing apparatus 102 after the print data was transmitted. The shared information 207 is information which is accessible from each unit in common, and is a file saved in the external storage device 114 or information stored on the RAM 113. The management information display unit 208 is a display control unit which includes a vendor-specific information control unit 209, and which obtains vendor-specific information from the printing apparatus 102 and transmits a vendor-specific command to the printing apparatus 102. Note that in a case where the units in the extension application 204 communicate with each other, the communication is indirectly performed via the extension application 204.

The extension application 204 writes and reads out information into and from the shared information 207 by using an API (Application Program Interface) provided by the OS. Including the shared information 207 accessible from each unit in common makes it possible to prevent overlapped management of information and relieve capacity shortage of the external storage device 114 or the RAM 113. Note that the operation of the extension application 204 may end every time the processing of each unit ends. In this case, the OS activates the extension application 204 every time the OS receives a request for using each unit. In addition, for example, although the OS ends the operation of the extension application 204 in a case where the processing of that print data editing unit 205 is ended, the OS may keep the extension application 204 activated even after the processing of the printing apparatus monitoring unit 206 is ended.

Next, the printing apparatus 102 will be described. The printing apparatus 102 holds management information 210. The management information 210 contains information such as a number for identifying an error occurring in the printing apparatus 102 (error number), an ink remaining amount, a document name of a job being executed in the printing apparatus 102, information indicating a state of the job, an owner name, the number of print pages, and a URL of an ink purchase site. The management information 210 can be obtained by an IPP communication using the printing apparatus monitoring unit 206 or by a unique-protocol communication using the vendor-specific information control unit 209 included in the management information display unit 208. In the present embodiment, management information which is obtained by the printing apparatus monitoring unit 206 through communication of an OS-standard protocol (a communication protocol designated by the OS, for example, the aforementioned IPP), and which can be interpreted by the OS is referred to as "first management information". In addition, management information obtained by the vendor-specific information control unit 209 of the management information display unit 208 through the unique-protocol communication, or management information which is obtained by the vendor-specific information control unit 209 of the management information display unit 208 through the OS-standard protocol but which cannot be interpreted by the OS is referred to as "second management information". A difference in content between the first and second management information will be described later. Note that in the present embodiment, the first and second management information is obtained directly from the printing apparatus 102, but may be obtained indirectly via a server, which is not shown, for example.

Upon receipt of a print request from the user, the application 201 issues a print instruction to the OS. Upon receipt of the print instruction from the OS, the print data generating software 202 converts intermediate data provided from the OS to print data which can be interpreted by the printing apparatus 102. The OS passes the print data obtained by the conversion to the print data editing unit 205 of the extension application 204. The OS may be further configured to pass print setting information contained in the intermediate data to the print data editing unit 205.

The OS transmits the print data edited by the print data editing unit 205 to the printing apparatus 102. In this event, the OS activates the printing apparatus monitoring unit 206. After the transmission of the print data, the printing apparatus monitoring unit 206 monitors whether an error is occurring in the printing apparatus 102. The printing apparatus 102 prints a sheet based on the print data edited by the extension application 204 and transmitted from the OS.

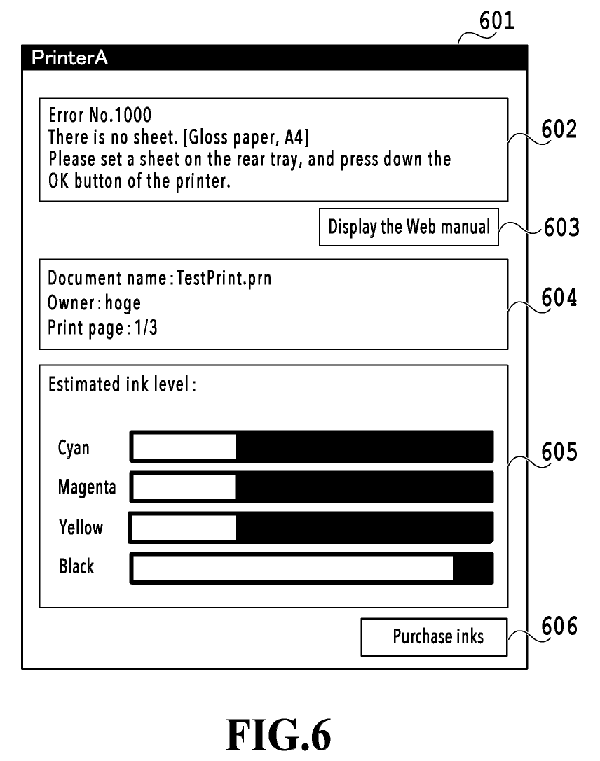

The printing apparatus monitoring unit 206 has a function of causing the OS to perform a toast notification in a case where the printing apparatus monitoring unit 206 has detected an error such as an out-of-sheet error at the time of printing. Here, the toast notification means that a small area of a rectangle or the like (generally called "pop-up", or "toast") is temporarily displayed at an end of the screen to notify the user of occurrence of an error, or the like. In a case where the user has performed an operation such as click, double-click, mouse over, keyboard operation, or touch on the displayed toast, the management information display unit 208 performs display control of displaying, on the screen, detailed information on the printing apparatus 102. For example, the management information display unit 208 performs display control of displaying, on the display unit 119, a GUI as shown in FIG. 6, which will be described later. This GUI contains information which is more detailed than the toast notification. The detail of the GUI in this event will be described later.

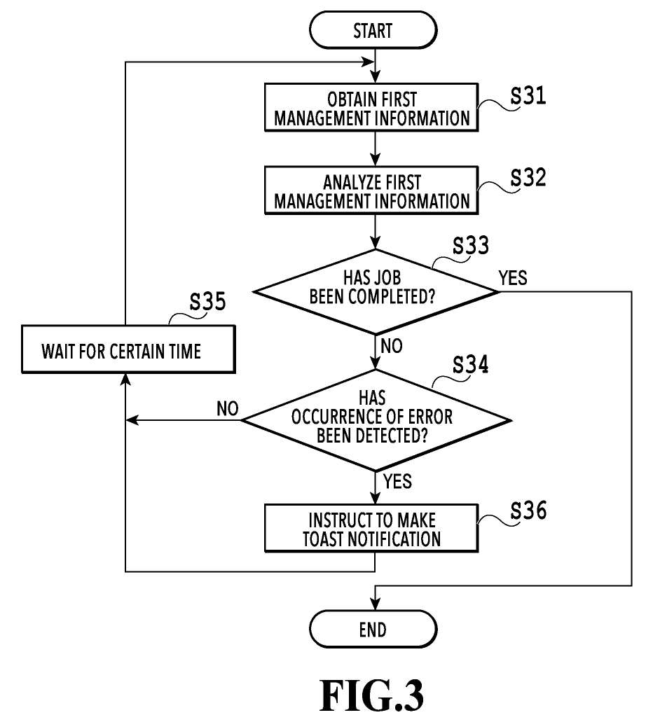

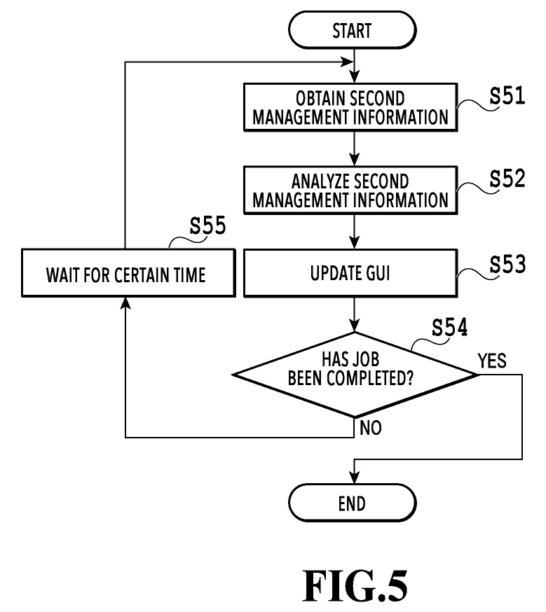

The detail of the processing flow of the printing apparatus monitoring unit 206 will be described later with reference to FIG. 3. In addition, the detail of the processing flow of the management information display unit 208 will be described later with reference to FIG. 5. Note that in the present embodiment, the configuration of the extension application 204 is not limited to the configuration having all the aforementioned functions, but may be a configuration having some of the functions, or may be a configuration having another function.

As described above, the extension application 204 has at least one of the function of display control of various setting screens, the function of editing print data to be inputted into the printing apparatus, and the function of extending the functions which can be designated in the print data generating software 202.

### Processing Flow of Printing Apparatus Monitoring Unit

Upon transmitting print data (job) to the printing apparatus 102 through the print data editing unit 205, the OS activates the printing apparatus monitoring unit 206. A flowchart shown in FIG. 3 is processing executed by the printing apparatus monitoring unit 206 of the extension application 204. Specifically, the series of processing shown by the flowchart of FIG. 3 is implemented by the CPU 111 deploying the program of the extension application 204, which is stored in the ROM 112, onto the RAM 113, and executing the program. Note that sign "S" in the description of each processing means a step in the flowchart, and the same applies to flowcharts after FIG. 3.

In S31, the printing apparatus monitoring unit 206 periodically obtains first management information from the printing apparatus 102 by using, for example, "Get-Printer-Attributes Request", which is a printer attribute obtaining request of the IPP. Alternatively, the printing apparatus monitoring unit 206 obtains first management information from the printing apparatus 102 by using "Get-Job-Attributes Request", which is a job attribute obtaining request. Note that the printing apparatus monitoring unit 206 is controlled by the OS to obtain minimum required information such as information indicating the processing state of a job. Hence, for example, the printing apparatus monitoring unit 206 cannot obtain detailed information such as an error number of an error occurring in the printing apparatus 102, like information obtained by the management information display unit 208, which will be described later, using the vendor-specific information control unit 209.

Note that the "Get-Printer-Attributes Request" and the "Get-Job-Attributes Request" are printing APIs prepared in the OS.

In S32, the printing apparatus monitoring unit 206 analyzes the first management information obtained in S31. Specifically, the printing apparatus monitoring unit 206 checks whether information on an occurrence of an error in the printing apparatus 102 is contained in the management information obtained by using the "Get-Printer-Attributes Request". In addition, the printing apparatus monitoring unit 206 extracts information on the processing state of an execution target job from the management information obtained by using the "Get-Job-Attributes Request".

In S33, the printing apparatus monitoring unit 206 determines, from the analysis result in S32, whether the execution target job has been completed. If the printing apparatus monitoring unit 206 has determined that the execution target job has been completed, the printing apparatus monitoring unit 206 ends the monitoring processing. If the printing apparatus monitoring unit 206 has determined that the execution target job has not been completed, the printing apparatus monitoring unit 206 transitions to processing of S34.

In S34, the printing apparatus monitoring unit 206 determines, from the analysis result in S32, whether an occurrence of an error in the printing apparatus 102 has been detected. If the printing apparatus monitoring unit 206 has determined that an error is occurring in the printing apparatus 102, the printing apparatus monitoring unit 206 transitions to processing of S36. If the printing apparatus monitoring unit 206 has determined that an error is not occurring in the printing apparatus 102, the printing apparatus monitoring unit 206 transitions to processing of S35.

In S35, the printing apparatus monitoring unit 206 performs wait processing for a certain time. Then, after completing the wait processing, the printing apparatus monitoring unit 206 transitions to processing of S31. The time for the wait processing may be fixed, or may be dynamically changed depending on the size of an execution target job, for example.

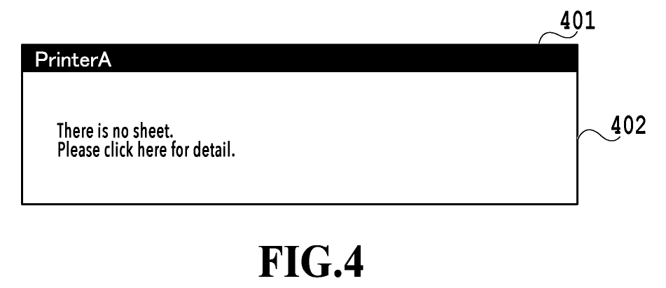

In S36, the printing apparatus monitoring unit 206 instructs the OS to make a toast notification. FIG. 4 is a diagram showing an example of a toast to be displayed by the toast notification. The toast shown in FIG. 4 has a title bar 401 and a message display section 402. In the title bar 401, an application name, a printer name, or the like is shown. In the message display section 402, a message indicating the state of the printing apparatus 102 is shown. In addition, in the message display section 402, a guidance using a BMP image (bitmap image) or an animation may be shown. In a case where the user performs a predetermined operation such as a click operation on the message display section 402, the management information display unit 208 is activated, and the user can know more detailed information on the printing apparatus 102. At this time, the printing apparatus monitoring unit 206 obtains screen configuration information of the toast notification from the shared information 207. The screen configuration information of the toast notification which is held by the shared information 207 includes, for example, information such as a text of a message for a notification, still-image data of a bitmap image, or moving-image data of an animation.

The above is the processing flow of the printing apparatus monitoring unit 206. Note that a configuration may be employed in which the print data generating software 202 or the OS, which is not shown, has the same functions as the printing apparatus monitoring unit 206, and the print data generating software 202 or the OS performs all or part of the processing of the flowchart of above-mentioned FIG. 3.

### Processing Flow of Management Information Display Unit

A flowchart shown in FIG. 5 is processing executed by the management information display unit 208 of the extension application 204 according to the present embodiment. Specifically, the series of processing shown by the flowchart of FIG. 5 is implemented by the CPU 111 deploying the program of the extension application 204, which is stored in the ROM 112, onto the RAM 113, and executing the program. Note that in the present embodiment, the OS activates the management information display unit 208 in response to the user performing an operation such as a click on the toast based on the toast notification made in S36 of FIG. 3. As mentioned above, once activated by the OS, the management information display unit 208 displays, on the display unit 119, a GUI containing detailed information on the printing apparatus 102. That is, during the processing of the present flow, the management information display unit 208 is performing the display control of the GUI on the display unit 119 of the host computer 101.

In S51, the management information display unit 208 obtains second management information from the printing apparatus 102. The second management information is information obtained by the vendor-specific information control unit 209 from the printing apparatus 102, and is information containing at least vendor-specific information such as an error number or a URL of an ink purchase site, for example, which is not contained in the first management information obtained in S32. Note that it is assumed that the second management information of the present embodiment contains all the first management information. However, the second management information does not have to contain the first management information at all, or may contain only part of the first management information. As mentioned above, the vendor-specific information control unit 209 makes an inquiry to the printing apparatus 102 by using a unique protocol to obtain the second management information. In this event, in order to reduce the communication traffic, the vendor-specific information control unit 209 may make an inquiry to the printing apparatus 102 about only information which is not contained in the first management information obtained in S31. In the case of making an inquiry to the printing apparatus 102 about information other than the information obtained in S31, the first management information obtained in S31 may be written out in the shared information 207 to allow the management information display unit 208 to determine information which is not contained in the information. Note that although the present embodiment employs a configuration of obtaining vendor-specific information by using a unique protocol, the vendor-specific information may be defined as an extended attribute of IPP, which is an OS-standard protocol, for example. In this event, the vendor-specific information control unit 209 may obtain vendor-specific information by using an API of "Get-Printer-Attributes Request" which is a printer attribute obtaining request of the IPP, or the like. In this case, based on a condition that the extension application 204 is notified by the OS of an event which allows processing using the API to be executed, the vendor-specific information control unit 209 may designate information desired to be obtained, and execute the API to obtain vendor-specific information.

In S52, the management information display unit 208 analyzes the second management information obtained in S51. Specifically, the management information display unit 208 extracts, from the second management information, information such as an error number corresponding to an error occurring in the printing apparatus 102, an ink remaining amount, a document name of a job being executed in the printing apparatus 102, an owner name, the number of print pages, or a URL of an ink purchase site.

In S53, the management information display unit 208 updates the GUI based on the analysis result obtained in S52. Specifically, the management information display unit 208 obtains, from the shared information 207, a resource such as a message or a bitmap image corresponding to the error number of the error occurring in the printing apparatus 102, and reflects the resource in the GUI. In this way, the display content of the GUI in the display unit 119 is updated. Note that since the processing is repeated in the present flowchart, S53 is expressed as "UPDATE GUI"; however, in S53 immediately after the flowchart of FIG. 5 is started, "DISPLAY GUI" is performed. Here, a specific example of the GUI will be described.

### Specific Example of GUI

FIG. 6 shows an example of a GUI to be displayed on the display unit 119 of the host computer 101. The GUI shown in FIG. 6 includes a title bar 601, a message display section 602, a WEB manual display button 603, a job information display section 604, an ink information display section 605, and an ink purchase button 606. In the title bar 601, an application name, a printer name, or the like is displayed. In the message display section 602, a message indicating the state of the printing apparatus 102 is displayed. For example, in a case where an out-of-sheet error is occurring in the printing apparatus 102, an error number and an explanation for the phenomenon, a removing method, and information on the kind and size of a sheet to be set are displayed as messages. The WEB manual display button 603 is a button for displaying a WEB manual. In a case where the user has pressed down the WEB manual display button 603, a default browser of the system is activated, and a page corresponding to the error number in the WEB manual prepared by the vendor is displayed. In the page corresponding to the error number in the WEB manual, the user can watch, for example, a video content about an error removing method, and can thus more intuitively perform a work or the like necessary for removing the error. In the job information display section 604, information on the job being executed is displayed. In the ink information display section 605, information on the inks used in the printing apparatus 102 is displayed. The ink purchase button 606 is a button for purchasing the inks. In a case where the user has pressed down the ink purchase button 606, the default browser of the system is activated, and an ink purchase page prepared by the vendor is displayed. The URL information on the ink purchase page is different for each model, and is contained in vendor-specific information obtained by the management information display unit 208.

As described above, the GUI contains an error number, an ink remaining amount, a document name of a job being executed, an owner name, the number of print pages, a URL of an ink purchase site, and the like, and the user can grasp more detailed information on the printing apparatus 102 as compared with the aforementioned toast notification. For example, the user can know, from the GUI, a method for removing an error, the detail of which is difficult to grasp by looking at the toast notification only, so that the removing operation is facilitated. Explanation is returned to the flowchart of FIG. 5.

In S54, the management information display unit 208 determines whether the execution target job has been completed, from the analysis result obtained in S52. Specifically, the management information display unit 208 determines whether an error state has been reset by a user operation or the like and the printing has normally ended. If the management information display unit 208 has determined that the execution target job has been completed, the management information display unit 208 ends the process. The management information display unit 208 ends the display of the GUI in conjunction with the ending of the process. Note that the display of the GUI does not have to be ended in conjunction with the ending of the process. If the management information display unit 208 has determined that the execution target job has not been completed, the management information display unit 208 transitions to processing of S55.

In S55, the management information display unit 208 performs wait processing for a certain time. Then, after completing the wait processing, the management information display unit 208 transitions to processing of S51. The time for the wait processing may be fixed, or may be dynamically changed depending on the size of an execution target job, for example.

Once the cause of the error is reset by addressing or the like by the user based on the information obtained via the GUI, the execution of the job which has been interrupted, for example, is restarted in the printing apparatus 102. If it is determined that the job has been completed in the printing apparatus 102 from the analysis result of the second management information obtained subsequent S51 (Yes in S54), the series of processing of the flowchart of FIG. 5 (that is, the display and update processing of the GUI) ends. The above is the processing flow of the printing apparatus monitoring unit 206.

### Modification

The above-mentioned embodiment employs the configuration in which a resource such as a message or a bitmap image corresponding to an error number to be displayed on the GUI is obtained from the shared information 207; however, the configuration is not limited to this. For example, the management information display unit 208 may download screen configuration information stored in a specific server on the Internet and use the screen configuration information for the display control of the GUI. Moreover, the error notification method does not have to be limited to a toast notification, and the notification may be made to a timeline function which Windows 10 (registered trademark) supports, for example.

In addition, the above-mentioned embodiment has been described such that in a case where an error occurs in the printing apparatus 102, a GUI containing detailed information of the error and the like is displayed; however, a GUI as shown in FIG. 6 may be displayed in a case where no error is occurring. In this case, for example, a GUI which does not contain the WEB manual display button 603 may be displayed, or a GUI in which the WEB manual display button 603 is grayed out and thus cannot be pressed down may be displayed.

In addition, the above-mentioned embodiment takes a mode in which the management information display unit 208 is activated to perform the display control of the GUI in response to the user clicking the toast according to the toast notification in S36; however, the activation method or the GUI display timing is not limited to this. For example, a mode may be employed in which the management information display unit 208 is kept activated as a resident program in a state where no GUI is displayed, and the display control of the GUI is performed in a case where it is detected that printing is started in the printing apparatus 102 or in a case where an error occurs.

As described above, according to the present embodiment, it is possible to notify the user of detailed information occurring in the printing apparatus by using an extension application of an OS-standard driver. More specifically, using the management information display unit 208 enables GUI display control of error information and the like on a printing apparatus, and makes it easy for the user to grasp the status of the printing apparatus. In addition, a vendor-specific function such as a link function to a WEB manual page corresponding to an error number or a link function to an ink purchase page corresponding to an error number can also be provided by using an extension application.

### Second Embodiment

Errors which occur in the printing apparatus 102 include errors which can be reset by directly operating the printing apparatus 102 and error which can be reset by transmitting a control command to the printing apparatus 102. For example, an error relating to cover open of a printer is an error whose error state can be reset by directly operating the cover of the printer. On the other hand, a print head position unadjusted error which occurs in a case where print head position adjustment has not been performed is an error whose error state can be reset by transmitting, from the host computer 101, a control command for performing print head position adjustment.

Here, for an error whose error state can be reset by transmitting a control command from the host computer 101, it is desirable that a function of issuing an error reset command can also be provided in making an error notification by the management information display unit 208. In view of this, a system which transmits a control command to reset an error state in a case where a detected error is an error which can be reset by transmitting a control command will be described as Embodiment 2. Note that the basic configuration of the printing system is the same as that in Embodiment 1, and the description thereof will be omitted. Hereinafter, a processing flow of the management information display unit 208, which is a difference from Embodiment 1 will be described.

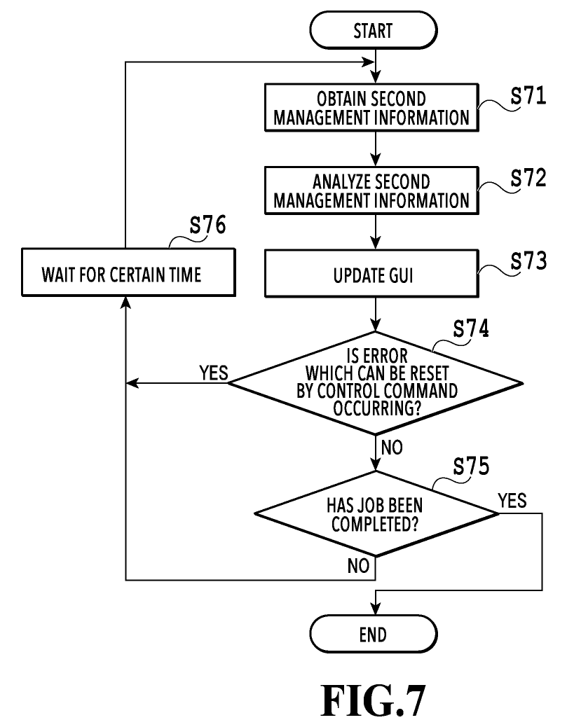

A flowchart shown in FIG. 7 is processing executed by the management information display unit 208 of the extension application 204 according to the present embodiment. Note that S71 and S72 are the same processing as S51 and S52 of FIG. 5, and the description thereof will be omitted.

In S73, the management information display unit 208 updates the GUI based on the analysis result obtained in S72. Specifically, the management information display unit 208 obtains, from the shared information 207, a resource such as a message or a bitmap image corresponding to an error number of an error occurring in the printing apparatus 102, and reflects the resource in the GUI. In this event, in a case where the error has been detected and is an error which can be reset by a control command supported by the management information display unit 208, a button for removing the error is provided on the GUI. The management information display unit 208 may determine, based on the error number, whether the detected error is an error which can be reset by a control command. Note that since the processing could be repeated in the present flowchart, S73 is expressed as "UPDATE GUI"; however, in S73 immediately after the flowchart of FIG. 7 is started, "DISPLAY GUI" is performed. Here, a specific example of the GUI will be described.

### Specific Example of GUI

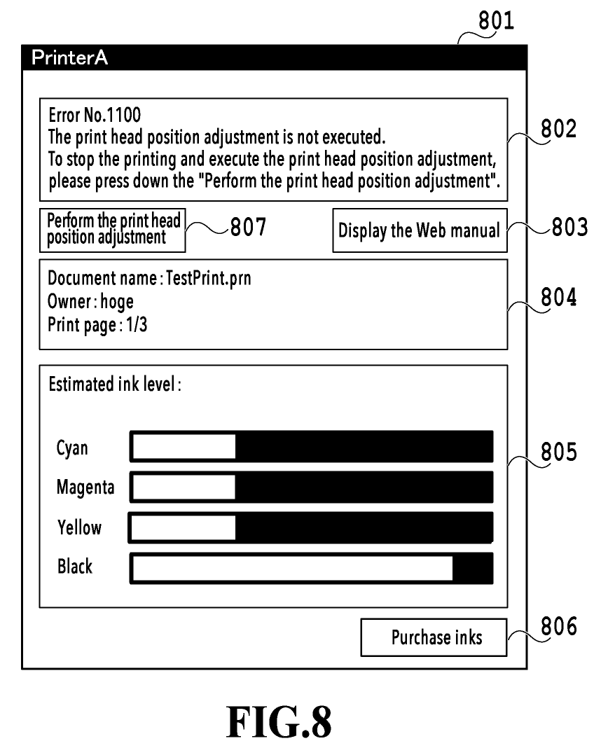

FIG. 8 shows an example of a GUI to be displayed on the display unit 119 of the host computer 101. The GUI shown in FIG. 8 includes a title bar 801, a message display section 802, a WEB manual display button 803, a job information display section 804, an ink information display section 805, an ink purchase button 806, and an error removal button 807. Here, only portions different from the GUI shown in FIG. 6 will be described.

In the message display section 802, a message indicating the state of the printing apparatus 102 is displayed. For example, in a case where a head position unadjusted error is occurring in the printing apparatus 102, an error number, an explanation for the phenomenon, and an explanatory message for a removing method are displayed.

The error removal button 807 is a button for removing an error of a type which can be reset by a control command. In FIG. 8, the button display is "Perform the head position adjustment". In this way, the displayed name of the error removal button 807 may be changed in accordance with the name of the control command to be transmitted. By pressing down the error removal button 807, the user can reset the error state occurring in the printing apparatus 102. In this event, the management information display unit 208 generates an error reset command, and transmits the error reset command to the printing apparatus 102, through the vendor-specific information control unit 209. The error reset command may be transmitted, for example, by using a communication protocol of HTTP, or a control command may be generated as a job to transmit the job to a print port. Alternatively, the management information display unit 208 may activate the default browser of the system and display a maintenance screen of a WEB browser included in the printing apparatus 102, allowing error removal to be performed from on the WEB browser. Note that in a case where a control command is transmitted in response to the pressing down of the error removal button 807, the management information display unit 208 continues the monitoring processing until the error removal by the control command is completed.

In S74, the management information display unit 208 determines whether an error which can be reset by a control command supported by the management information display unit 208 is occurring. Specifically, the management information display unit 208 executes the control command which the printing apparatus 102 has received from the host computer 101, and in a case where the management information display unit 208 has confirmed, from the analysis result of the second management information, that the error state has been reset, the management information display unit 208 determines that an error which can be reset by control command is not occurring. That is, the management information display unit 208 does not determine that an error state has been reset in a case where the host computer 101 has transmitted a control command to the printing apparatus 102 only. If the management information display unit 208 has determined that an error which can be reset by a control command supported by the management information display unit 208 is occurring, the management information display unit 208 transitions to processing of S76, and continues the monitoring. As a result of the determination, if the management information display unit 208 has determined that an error which can be reset by a control command supported by the management information display unit 208 is not occurring, the management information display unit 208 transitions to processing of S75. Once the error state is reset by the pressing down of the error removal button 807 on the GUI, the job which has been interrupted, for example, is restarted in the printing apparatus 102. Thereafter, if it is determined that the job has been completed in the printing apparatus 102 from the analysis result of the second management information obtained in S71 (Yes in S75), the series of processing of the flowchart of FIG. 7 (that is, the display and update processing of the GUI) ends.

In S75, the management information display unit 208 determines whether the execution target job has been completed from the analysis result obtained in S72. If the management information display unit 208 has determined that the execution target job has been completed, the management information display unit 208 ends the process. The management information display unit 208 ends the display of the GUI in conjunction with the ending of the process. Note that the display of the GUI does not have to be ended in conjunction with the ending of the process. If the management information display unit 208 has determined that the execution target job has not been completed, the management information display unit 208 transitions to processing of S76.

In S76, the management information display unit 208 performs wait processing for a certain time. Then, after completing the wait processing, the management information display unit 208 transitions to processing of S71. The time for the wait processing may be fixed, or may be dynamically changed depending on the size of an execution target job, for example. The above is the processing flow of the printing apparatus monitoring unit 206.

### Modification Example

The above-mentioned embodiment is configured such that the error reset command is transmitted to the printing apparatus 102 upon detecting the pressing down of the error removal button 807 on the GUI; however, the configuration is not limited to this. For example, in a case where a certain time has elapsed after the management information display unit 208 detected an error occurring in the printing apparatus 102, a command for removing the error may be automatically generated and transmitted to the printing apparatus 102.

As described above, according to the present embodiment, it is possible to provide a user with functions of notifying the user of an error occurring in the printing apparatus 102 and transmitting a control command for removing the error state by using an extension application of an OS-standard driver.

### Third Embodiment

Next, an aspect in which the management information display unit 208 switches a display content of a GUI depending on the type, the connection method, and the like of the printing apparatus 102 connected to the host computer 101 will be described as Embodiment 3. In the following description, the description of contents common with the aforementioned Embodiment 1 will be omitted, and the switching of a GUI depending on the type or the like of the printing apparatus 102 which is a different from Embodiment 1 will be described. In addition, in terms of the same configurations as in Embodiment 1, the same signs are added, or the same names are used, so that the description thereof is omitted as appropriate.

### Overview of Management Information Display Function

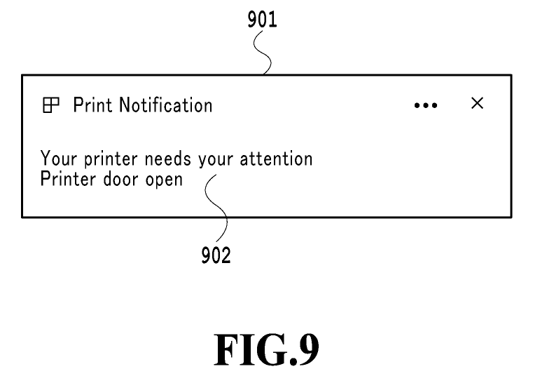

First, an overview of a management information display function provided by the management information display unit 208 of the extension application 204 of the present embodiment will be described. A flow until the management information display unit 208 of the present embodiment displays, on the display unit 119, a GUI based on the second management information obtained from the printing apparatus 102 is as follows.
1) In a case where the printing apparatus monitoring unit 206 has detected an error for a job being executed in the printing apparatus 102, based on the first management information obtained from the printing apparatus 102, the printing apparatus monitoring unit 206 instructs the OS to execute a toast notification.
2) The OS which has received the instruction executes the toast notification. FIG. 9 shows an example of a toast according to the toast notification in this case. In a toast 901 of FIG. 9, a message 902 indicating an overview of the error occurring in the printing apparatus 102 is displayed.
3) In response to a user operation (for example, click) on the toast, the OS calls the management information display unit 208 of the extension application 204 associated with the printing apparatus 102.
4) The management information display unit 208 which has been called displays, on the display unit 119, a GUI based on the second management information obtained from the printing apparatus 102.

### Screen Configuration of GUI

Subsequently, a screen configuration of a GUI based on the second management information will be described. The GUI provided by the management information display unit 208 of the present embodiment has different screen configurations depending on the type of the printing apparatus 102 (an inkjet method/an electrophotographic method, whether or not a maintenance cartridge is mounted, or the like) and the connection method of the printing apparatus 102 (a local connection or a cloud connection). Here, the local connection indicates a configuration in which the printing apparatus 102 and the host computer 101 are connected by a USB, a LAN cable, or the like in such a manner as to be capable of directly communicating with each other. In a case where the connection method is a local connection, print data generating software 202 configured to perform processing on the premise of a local connection is used. In addition, the cloud connection indicates a connection method in which the printing apparatus 102 and the host computer 101 are not connected in such a manner as to be capable of directly communicating with each other, and printing is executed via a cloud printing system configured on a cloud. In a case where the connection method is a cloud connection, print data generating software 202 configured to perform processing on the premise of a cloud connection is used. The size of the GUI provided by the management information display unit 208 can be changed by the user. In a case where the size has been changed, the management information display unit 208 stores the size after the change, and displays the GUI with the stored size at the time of next activation.

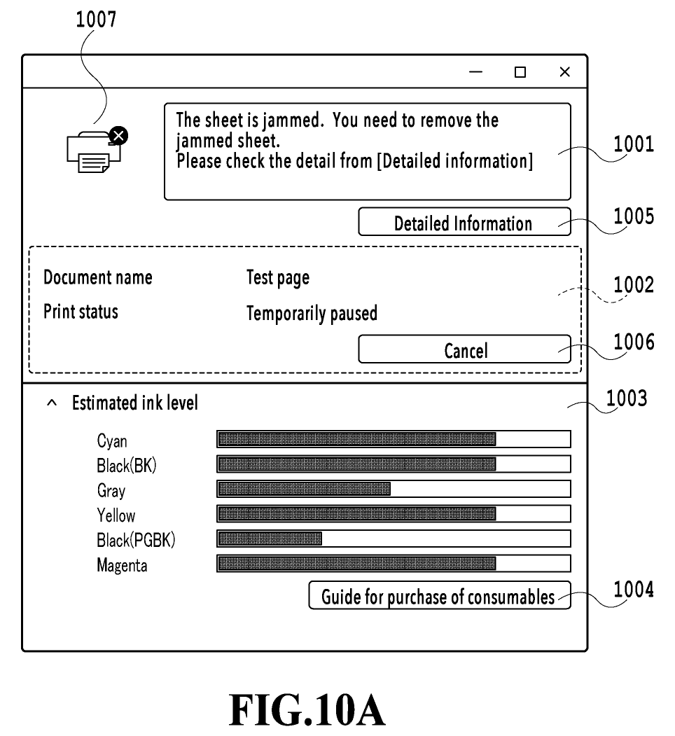

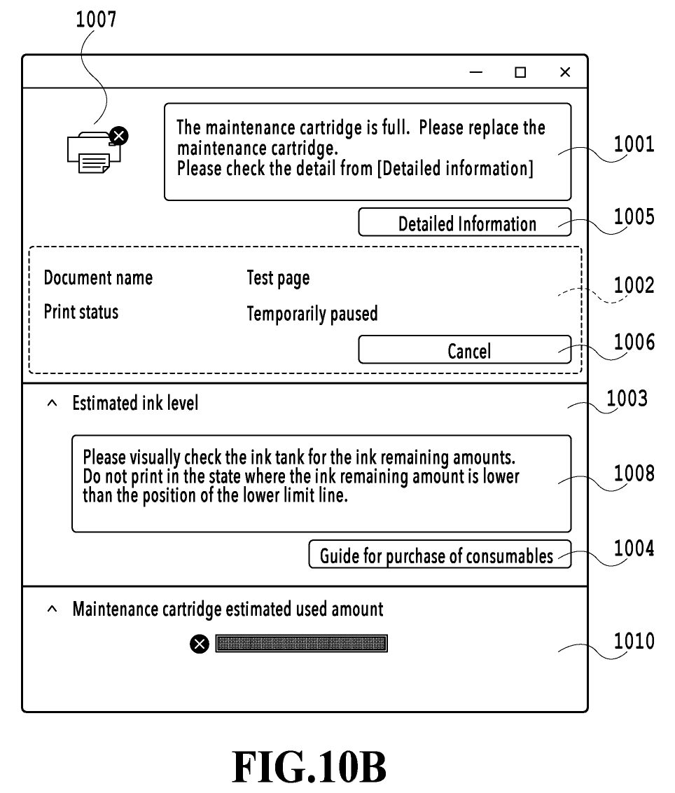

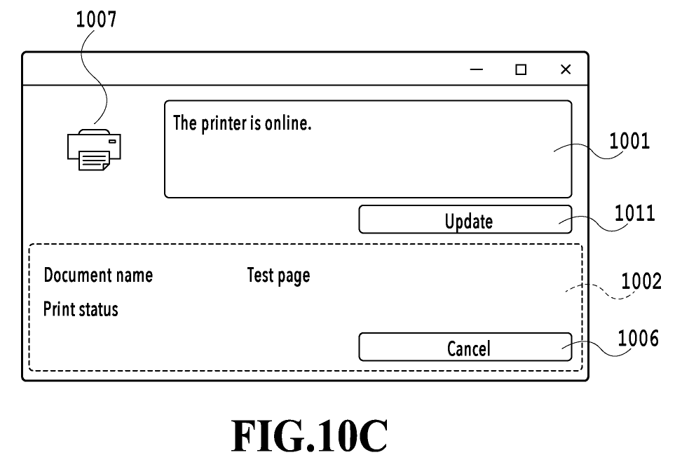

FIGS. 10A-10C are diagrams showing examples of screen configurations of GUIs provided by the management information display unit 208 of the present embodiment. FIGS. 10A and 10B are GUIs in a case where the printing method of the connected printing apparatus 102 is an inkjet method. FIG. 10C is a GUI in a case where the printing method of the connected printing apparatus 102 is an electrophotographic method or in a case where the connection method is a cloud connection. In addition, the GUI of FIG. 10A corresponds to a printing apparatus of a type in which the user cannot visually check the ink remaining amount, and the GUI of FIG. 10B corresponds to a printing apparatus of a type in which the user can visually check the ink remaining amount. An example of the printing apparatus of the type in which the user cannot visually check the ink remaining amount includes a printing apparatus in which a large-capacity ink tank is mounted. Hereinafter, the screen configurations of the respective GUIs shown in FIGS. 10A-10C will be described.

### Screen Configuration of GUI of FIG. 10A

As mentioned above, the GUI shown in FIG. 10A shows an example of a screen configuration of a GUI for the connected printing apparatus 102 that is a printing apparatus of an inkjet method and is a printing apparatus of a type in which the user cannot visually check the ink remaining amount. The GUI of FIG. 10A includes a first message display section 1001, a job information display section 1002, an ink information display section 1003, an ink purchase button 1004, a remote UI display button 1005, a cancel button 1006, and an icon display section 1007.

In the first message display section 1001, a message indicating the state of the printing apparatus 102 is displayed. For example, in a case where a sheet jam error is occurring in the printing apparatus 102, an explanation for the phenomenon and a message prompting an operation of checking the detail are displayed. In the job information display section 1002, information on the job being executed is displayed. In the ink information display section 1003, information on the inks used in the printing apparatus 102 is displayed. The ink purchase button 1004 is a button for purchasing the inks. In a case where the user has pressed down the button 1004, the default browser of the system is activated, and an ink purchase page prepared by the vendor is displayed. The URL information of the ink purchase page is different for each model, and is contained in vendor-specific information of the second management information obtained by the management information display unit 208. In a case where the printing apparatus 102 is in a state of a specific setting (for example, a setting indicating that the printing apparatus 102 is in a state where the inks can be used under conditions agreed under contract), the management information display unit 208 of the present embodiment performs such control that the ink purchase button 1004 is not displayed. Moreover, in a case where a regional setting of the OS indicates a specific region, the management information display unit 208 performs such control that the ink purchase button 1004 is not displayed. The remote UI display button 1005 is a button for displaying a remote UI screen provided by the printing apparatus 102. In a case where the user has pressed down the remote UI display button 1005, the management information display unit 208 activates the Web browser and displays, on the Web browser, the remote UI screen provided by the printing apparatus 102. The remote UI screen provides functions of displaying the error state of the printing apparatus 102 and the status of a job being executed, functions of designating the setting and operation of the printing apparatus 102, and the like. The cancel button 1006 is a button for canceling the job being executed by the printing apparatus 102 (the target job for a toast notification). In a case where the cancel button 1006 is pressed down, the management information display unit 208 notifies the OS that there has been a cancel instruction. Upon receipt of this notification, the OS transmits the cancel instruction to the printing apparatus 102. Upon receipt of this cancel instruction, the printing apparatus 102 cancels the job being executed. Note that in a case where the connection method is a cloud connection, the cancel instruction is transmitted to the printing apparatus 102 via a cloud printing system which is not shown. In addition, in a case where the cancel button 1006 has been pressed down, the management information display unit 208 makes a cancel instruction for the job according to the toast notification, and then ends the display of the GUI to the display unit 119. In the icon display section 1007, an icon based on the content of the second management information obtained from the printing apparatus 102 is displayed.

### Screen Configuration of GUI of FIG. 10B

As mentioned above, the GUI shown in FIG. 10B shows an example of a screen configuration of a GUI for the connected printing apparatus 102 that is a printing apparatus of an inkjet method and is a printing apparatus of a type in which the user can visually check the ink remaining amounts. The GUI of FIG. 10B includes a first message display section 1001, a job information display section 1002, an ink information display section 1003, an ink purchase button 1004, a remote UI display button 1005, a cancel button 1006, and an icon display section 1007. Moreover, the GUI shown in FIG. 10B includes a second message display section 1008 and a maintenance cartridge information display section 1010. Hereinafter, differences from the GUI of FIG. 10A will be described.

In the second message display section 1008, a message for prompting the user to visually check the ink remaining amount is displayed in a case where the printing apparatus monitoring unit 206 cannot obtain a precise ink remaining amount of the printing apparatus 102. In the maintenance cartridge information display section 1010, in a case where remaining amount information of a maintenance cartridge is contained in the second management information obtained by the management information display unit 208, the remaining amount information is displayed. Here, the maintenance cartridge is a cartridge for accumulating, inside the printing apparatus 102, discharged inks which are no longer required. In a case where the remaining amount of the maintenance cartridge has run out, it is necessary to replace the maintenance cartridge in order to correctly dispose of discharged inks.

### Screen Configuration of GUI of FIG. 10

As mentioned above, the GUI shown in FIG. 10C shows an example of a screen configuration of a GUI for the connected printing apparatus 102 that is a printing apparatus whose connection method is a cloud connection or whose printing method is an electrophotographic method. The GUI shown in FIG. 10C includes a first message display section 1001, a job information display section 1002, a cancel button 1006, and an icon display section 1007 like the GUIs of FIGS. 10A and 10B. Moreover, the GUI shown in FIG. 10C includes an update button 1011. Hereinafter, features of the GUI of FIG. 10C will be described.

The update button 1011 is a button for manually updating the second management information. In the case of a cloud connection, the first management information obtained by the printing apparatus monitoring unit 206 is information having a poor real-time characteristic as compared with the case of a local connection because the first management information is transmitted via the cloud printing system. Hence, in a case where the connection method is a cloud connection, the management information display unit 208 does not execute periodical update processing of the second management information, which will be described later, but executes update processing of the second management information at a timing at which the update button 1011 is pressed down. Similarly, in a case where the printing apparatus 102 is of an electrophotographic method, the management information display unit 208 does not execute periodical update processing, but executes update processing of the second management information at a timing at which the update button 1011 is pressed down. In a printing apparatus of an electrophotographic method, it is often the case that the confirmation of the status of a job or the control of a job is performed by operating the printing apparatus 102. For this reason, in the case of an electrophotographic method, the management information display unit 208 of the present embodiment does not execute periodical update processing, but executes update processing of the second management information in accordance with an explicit instruction of the user.

### Processing of Obtaining Second Management Information

Subsequently, processing of obtaining the second management information by the management information display unit 208 will be described. The management information display unit 208 obtains the second management information from the printing apparatus 102 via the OS by using a unique protocol, and displays a GUI corresponding to the type or the like of the printing apparatus 102 based on the obtained information.

As mentioned above, in a case where the printing method of the printing apparatus 102 is an inkjet method and the connection method of the printing apparatus 102 is a local connection, the management information display unit 208 obtains the second management information from the printing apparatus 102 at predetermined intervals (for example, 4-second intervals), and performs automatic update of the GUI. On the other hand, in a case where the printing method is an electrophotographic method, the management information display unit 208 does not perform the periodical obtaining of the second management information and the automatic update of the GUI regardless of the connection method. In a case where the printing method is an inkjet method and the connection method is a cloud connection, the management information display unit 208 does not perform the periodical obtaining of the second management information and the automatic update of the GUI. That is, in these cases, the management information display unit 208 obtains the second management information from the printing apparatus 102 and performs the automatic update of the GUI at a timing at which the update button 1011 is pressed down by the user.

Note that in obtaining the second management information from the printing apparatus 102, if time-out has occurred due to a problem of communications or the like, the management information display unit 208 displays a generic error message in the first message display section 1001, which will be described later.

### Regarding Display Elements of GUIs

Subsequently, major UI elements in the GUIs shown in aforementioned FIGS. 10A-10C will be described. Hereinafter, the first message display section 1001, the job information display section 1002, the ink information display section 1003, the remote UI display button 1005, the icon display section 1007, and the maintenance cartridge information display section 1010 will be sequentially described in detail.

### First Message Display Section

First, the first message display section 1001 which is common to the GUIs shown in FIGS. 10A-10C will be described. As mentioned above, in the first message display section 1001, a message based on status information contained in the second management information of the printing apparatus 102 is displayed. Then, in a case where a plurality of errors or warnings are occurring in the printing apparatus 102, messages corresponding to the errors or warnings occurring together are displayed together. In a case where the management information display unit 208 has obtained the second management information from the printing apparatus 102, the management information display unit 208 reflects information on the errors/warnings returned from the OS in a list form on the GUI sequentially from the top. However, the management information display unit 208 may be controlled such that a priority order (display order) of errors is held in advance or obtained from an external apparatus, and so on, and the errors are displayed on the GUI based on the priority order. Note that in a case where a message to be displayed is not fitted in the region of the first message display section 1001, the management information display unit 208 may display a scroll bar, which is not shown. This makes it possible for the user to read all the text of the message by using the scroll bar.

As mentioned above, the management information display unit 208 of the present embodiment changes the content of a message to be displayed in the first message display section 1001 depending on the type or the like of the printing apparatus 102 even in a case where the content of status information contained in the second management information is the same.

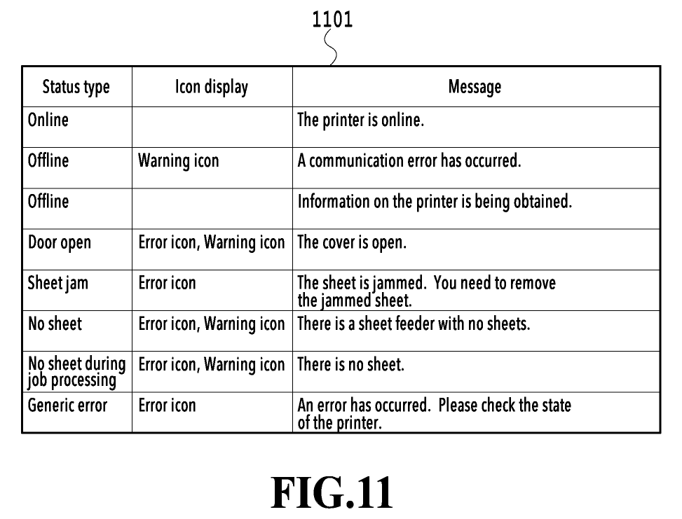

FIG. 11 is a message list in which messages to be displayed in the first message display section 1001 of the GUI of FIG. 10C are compiled, which is referred to in a case where the printing method is an electrophotographic method. A message list 1101 of FIG. 11 includes three items, "Status type", "Icon display", and "Message".

The item "Status type" indicates the type of status information contained in the second management information of the printing apparatus 102. The management information display unit 208 collates the type of the status information contained in the second management information obtained from the printing apparatus 102 with the contents described in the "Status type" of the message list 1101 of FIG. 11. Then, the management information display unit 208 specifies a coincident type, and displays, in the first message display section 1001, a message which is described in the item "Message" and corresponds to the specified type. For example, it is assumed that the type of the status information contained in the second management information is "No sheet". In this case, the management information display unit 208 displays, in the first message display section 1001, a message "There is a sheet feeder with no sheets." based on the message list 1101 of FIG. 11. The item "Icon display" indicates the content of an icon to be displayed in the icon display section 1007 in the GUIs of FIGS. 10A-10C.

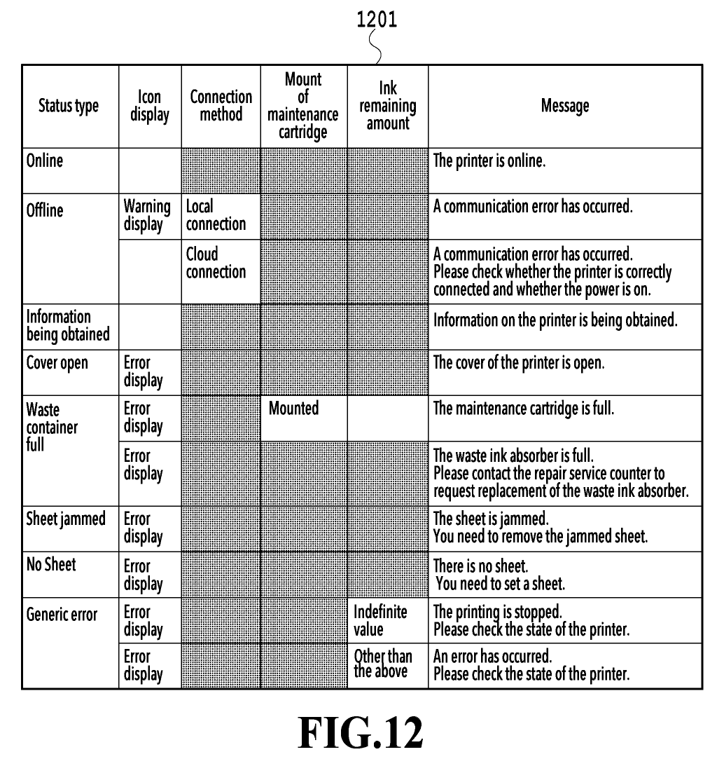

FIG. 12 is a message list in which messages to be displayed in the first message display section 1001 of the GUIs of FIGS. 10A or 10B are complied, which is referred to in a case where the printing method is an inkjet method. A message list 1201 of FIG. 12 includes six items, "Status type", "Icon display", "Connection method", "Mount of maintenance cartridge", "Ink remaining amount", and "Message". Among these, the items of "Status type", "Icon display", and "Message" have the same meanings as in the message list 1101 of FIG. 11, and the description thereof will be omitted. Hereinafter, differences are mainly described.

The management information display unit 208 collates the type of the status information contained in the second management information obtained from the printing apparatus 102 with the contents described in the "Status type" of the message list 1201 of FIG. 12. Then, the management information display unit 208 specifies a coincident type, and displays, in the first message display section 1001, a message which is described in the item "Message" and corresponds to the specified type. For example, it is assumed that the type of the status information contained in the second management information is "No sheet". In this case, the management information display unit 208 displays, in the first message display section 1001, a message "There is no sheet. You need to set a sheet." based on the message list 1201 of FIG. 12. Here, it can be seen that even in a case where the types of the status information are both "No sheet", the content of the message to be displayed in the first message display section 1001 is different from the above-mentioned case of an electrophotographic method. This is because the management information display unit 208 of the present embodiment switches the message list to be referred to in accordance with the printing method.

How the message to be displayed in the first message display section 1001 changes with reference to the message list 1201 of FIG. 12 can be summarized as follows.

In a case where the type of the status information is "Offline", the message is switched depending on whether the connection method is a local connection or a cloud connection. Specifically, in a case where the connection method of the printing apparatus 102 offline is a local connection, a message "A communication error has occurred." is displayed in the first message display section 1001. On the other hand, in a case where the connection method of the printing apparatus 102 offline is a cloud connection, a message "A communication error has occurred. Please check whether the printer is correctly connected and whether the power is on." is displayed in the first message display section 1001.

In a case where the type of the status information is "Waste container is full", the message is switched depending on whether a maintenance cartridge is mounted. Specifically, in a case where a maintenance cartridge is mounted, a message "The maintenance cartridge is full." is displayed in the first message display section 1001. On the other hand, in a case where a maintenance cartridge is not mounted, a message "The waste ink absorber is full. Please contact the repair service counter to request replacement of the waste ink absorber." is displayed in the first message display section 1001.

In a case where the type of the status information is "Generic error", the message is switched depending on whether the ink remaining amount is an indefinite value. Specifically, in a case where the ink remaining amount is an indefinite value, a message "The printing has been stopped. Please check the state of the printer." is displayed in the first message display section 1001. On the other hand, in a case where the ink remaining amount is other than an indefinite value, a message "An error has occurred. Please check the state of the printer." is displayed in the first message display section 1001.

Note that in the message list 1201 of FIG. 12, the items having case division are "Connection method", "Mount of maintenance cartridge", and "Ink remaining amount"; however, these are mere examples, and an item having case division may be provided besides these. In addition, in the message list 1201 of FIG. 12, in a case where the type of the status information is "Online", "Icon display" is blank. This indicates that in the case of online , the management information display unit 208 does not display, in the icon display section 1007, any icon indicating the state of an error or a warning.

### Job Information Display Section 1002

Next, the job information display section 1002 which is common to the GUIs shown in FIGS. 10A-10C will be described. As mentioned above, in the job information display section 1002, messages indicating a job name (document name) and the processing status (print status) of the job are displayed. Here, at a timing at which to display the GUI, the management information display unit 208 obtains, from the OS, a job name on a print queue managed by the OS and displays the job name in the job information display section 1002, and keeps displaying while the job of the job name is being executed. In addition, the message of the print status is displayed only in a case where the processing of the job has been started in the printing apparatus 102 at the time point at which the GUI is displayed.

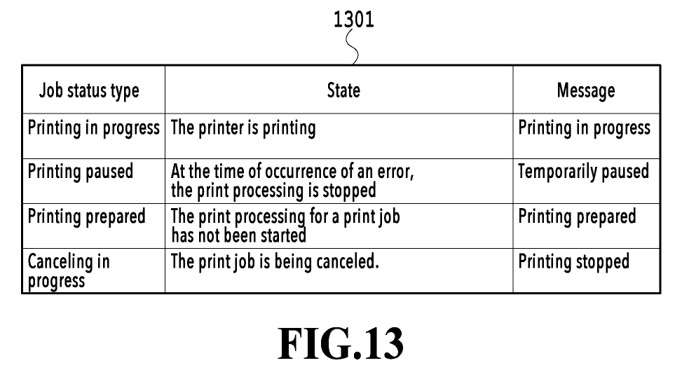

FIG. 13 is a message list in which messages to be displayed in the job information display section 1002 of the GUI of FIGS. 10A or 10B are compiled, which is referred to in the case of an inkjet method and a local connection. A message list 1301 of the FIG. 13 includes three items, "Job status type", "State", and "Message".

The item "Job status type" indicates the type of a processing status (print status) of a job contained in the second management information. The management information display unit 208 collates the type of a print status contained in the second management information obtained from the printing apparatus 102 with the contents described in the "Job status type" of the message list 1301 of FIG. 13. Then, the management information display unit 208 specifies a coincident type, and displays, in the job information display section 1002, a message which is described in the item "Message" and corresponds to the specified type. For example, it is assumed that the type of the print status contained in the second management information is "Printing paused". In this case, the management information display unit 208 displays a message "Temporarily paused" in the job information display section 1002 based on the message list 1301 of FIG. 13.

As mentioned above, the management information display unit 208 of the extension application 204 is called by the OS upon the pressing down of the toast according to the toast notification which is executed in a case where an error has occurred in the printing apparatus 102. Then, the management information display unit 208 displays, in the job information display section 1002 of a GUI, information on the job which has caused the toast notification. Note that since the management information display unit 208 displays a corresponding message based on the type of the print status contained in the second management information obtained from the printing apparatus 102, in a case where the job has not reached the printing apparatus 102 yet, a message indicating the print status is not displayed. In addition, in a case where the connection method of the printing apparatus 102 is a cloud method, since the management information display unit 208 cannot obtain second management information containing a print status from the printing apparatus 102, the management information display unit 208 does not display a message indicating the print status.

### Ink Information Display Section 1003

Next, the ink information display section 1003 in the GUI of FIG. 10A will be described. As mentioned above, in the ink information display section 1003 of the GUI of FIG. 10A, information on the inks used in the printing apparatus 102 of an inkjet method are displayed.

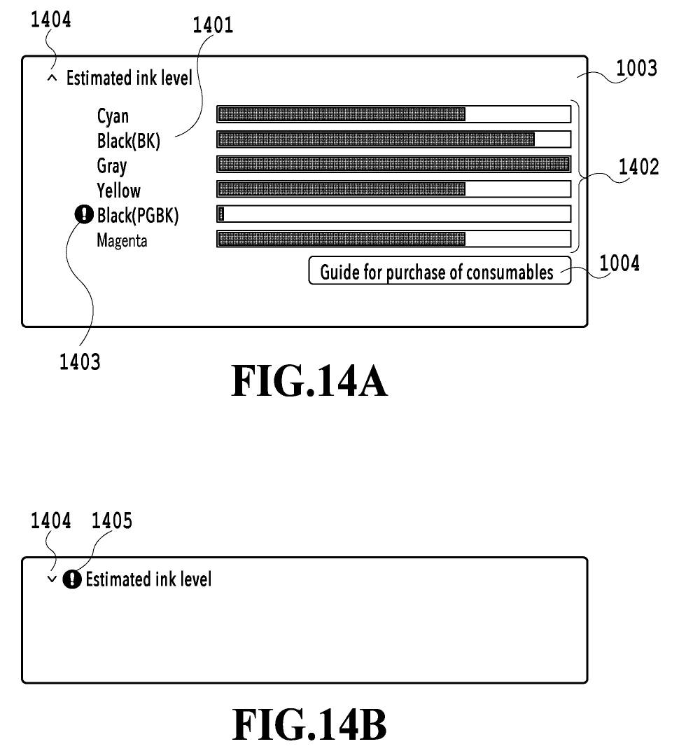

FIG. 14A is a diagram in which the portion of the ink information display section 1003 in the GUI of FIG. 10A is extracted. As shown in FIG. 14A, the ink information display section 1003 includes an ink name 1401, an ink remaining amount bar 1402, a warning icon 1403, and an expansion button 1404. In the ink name 1401, names of the respective inks determined based on ink information (more specifically, information on the ink tanks or ink cartridges mounted in the printing apparatus 102) contained in the second management information are displayed. In the ink remaining amount bar 1402, bars representing the ink remaining amounts determined based on the ink information (more specifically, remaining amount information on the respective inks) contained in the second management information is displayed for the respective inks. In this case, the colors of the respective bars are expressed by colors corresponding to the ink names. Note that in a case where the obtained second management information contains an unknown ink name, the bar corresponding to the unknown ink name is expressed by a color for an unknown color determined in advance. In addition, in a case where the ink remaining amount is unclear from the ink information contained in the second management information, the ink remaining amount bar 1402 is not displayed. The management information display unit 208 determines the arrangement order of the inks to be displayed in the ink information display section 1003, based on an order of the ink information contained in the second management information.

The display of the ink information display section 1003 can be switched between an expanded (displayed) state and an unexpanded (undisplayed) state by pressing down the expansion button 1404. The default is the expanded state shown in FIG. 14A, and the display is changed to the unexpanded state shown in FIG. 14B by pressing down the expansion button 1404. In a case where it is determined, based on the obtained ink information , that there is an ink whose ink remaining amount is small, the management information display unit 208 displays the warning icon 1403 to the right of the expansion button 1404. Even in the unexpanded state shown in FIG. 14B, in a case where it is determined, based on the obtained ink information, that there is an ink whose ink remaining amount is small, the management information display unit 208 displays the warning icon 1405 to the right of the expansion button 1404.

### Remote UI Display Button

Next, the remote UI display button 1005 which is common to the GUIs shown in FIGS. 10A and 10B will be described. In a case where the user has pressed down the remote UI display button 1005, the management information display unit 208 activates the web browser and displays, on the web browser, a remote UI screen provided by the printing apparatus 102. The management information display unit 208 displays the remote UI display button 1005 only in the case of an inkjet method and a local connection. By using the remote UI screen, the user can check model number information on the inks and an online manual. Note that the management information display unit 208 displays the remote UI display button 1005 only in a case where the management information display unit 208 was able to obtain information on the remote UI from the printing apparatus 102. In addition, in the case of a USB connection, the management information display unit 208 displays the remote UI display button 1005 only in a case where the management information display unit 208 has determined that the printing apparatus supports HTTP protocol communications via USB.

### Maintenance Cartridge Information Display Section

Next, the maintenance cartridge information display section 1010 in the GUI of FIG. 10B will be described. As mentioned above, in the maintenance cartridge information display section 1010, information on the maintenance cartridge used in the printing apparatus 102 of an inkjet method is displayed.

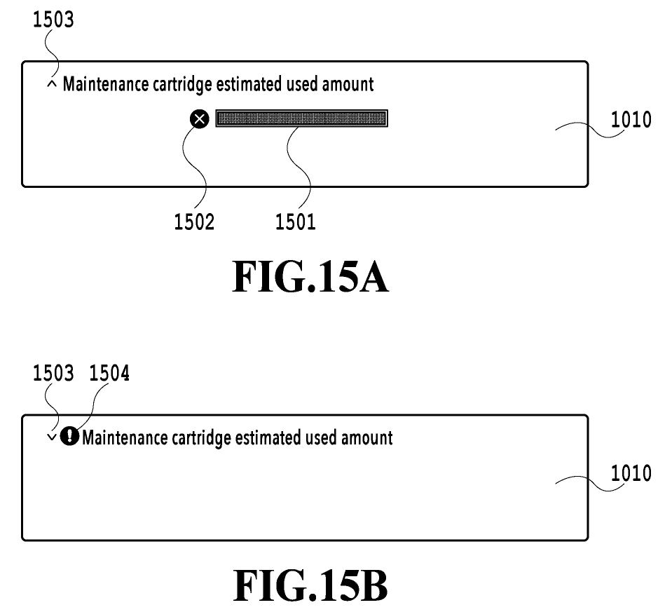

FIG. 15A is a diagram in which the portion of the maintenance cartridge information display section 1010 in the GUI of FIG. 10B is extracted. As shown in FIG. 15A, the maintenance cartridge information display section 1010 includes a maintenance cartridge estimated used amount bar 1501, a maintenance cartridge icon 1502, and an expansion button 1503. In the maintenance cartridge estimated used amount bar 1501, a bar which represents an estimated used amount determined based on information on the used amount of the maintenance cartridge contained in the second management information is displayed. Note that in a case where the estimated used amount cannot be determined because information on the used amount of the maintenance cartridge cannot be obtained from the second management information, or because of another reason, the management information display unit 208 does not display the maintenance cartridge estimated used amount bar 1501. In addition, based on status information on the maintenance cartridge contained in the obtained second management information, the management information display unit 208 displays the maintenance cartridge icon 1502 expressing the status.

The display of the maintenance cartridge information display section 1010 can be switched between an expanded (displayed) state and an unexpanded (undisplayed) state by pressing down the expansion button 1503. The default is the expanded state shown in FIG. 15A, and the display is changed to the unexpanded state shown in FIG. 15B by pressing down the expansion button 1503. In a case where it is determined, based on the obtained status information of the maintenance cartridge, that the estimated used amount has reached the upper limit, the management information display unit 208 displays the warning icon 1504 to the right of the expansion button 1503. Even in the unexpanded state shown in FIG. 15B, in a case where it is determined, based on the obtained status information of the maintenance cartridge, that the estimated used amount has reached the upper limit, the management information display unit 208 displays the warning icon 1504 to the right of the expansion button 1503.

### Icon Display Section

Next, the icon display section 1007 which is common to the GUIs of FIGS. 10A-10C will be described. In a case where the type (attribute) of the status information contained in the second management information is error, the management information display unit 208 displays an error icon in the icon display section 1007, while in a case where the type (attribute) of the status information contained in the second management information is warning, the management information display unit 208 displays a warning icon in the icon display section 1007. Here, in a case where the printing apparatus 102 returns a plurality of pieces of status information, if the type of one of the pieces of status information is error, the management information display unit 208 displays the error icon in the icon display section 1007. Note that, for example, in a case where the type of the status information is "Door open", there can be both cases where the management information display unit 208 displays the error icon in the icon display section 1007 and where the management information display unit 208 displays the warning icon in the icon display section 1007. This means that even in a case where the type of the status information is the same, there are a case where the printing apparatus 102 returns the attribute as error, and a case where the printing apparatus 102 returns the attribute as warning depending on the printing apparatus 102.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, detailed information occurring in the printing apparatus can be provided to the user.

This application claims the benefit of Japanese Patent Application No. 2025-069484, filed Apr. 21, 2025 which is hereby incorporated by reference herein in its entirety.

What is claimed is:

1. A non-transitory computer readable storage medium storing a program for causing a computer connected to a printing apparatus to execute the following processing:
obtaining second information from the printing apparatus in accordance with a predetermined operation performed on a predetermined notification executed based on first information which is obtained from the printing apparatus in accordance with IPP (Internet Printing Protocol), the second information containing at least information which is not contained in the first information; and
causing, based on the obtained second information, a display device to display information on the printing apparatus, the information on the printing apparatus corresponding to a type of the printing apparatus.

2. The storage medium according to claim 1, wherein
information displayed on the display device differs according to whether a printing method of the printing apparatus is an inkjet method or an electrophotographic method.

3. The storage medium according to claim 1, wherein
information displayed on the display device differs according to whether a connection method of the printing apparatus is a local connection or a cloud connection.

4. The storage medium according to claim 1, wherein
the second information is obtained by using Get-Printer-Attributes Request which is a printer attribute obtaining request of the IPP.

5. The storage medium according to claim 1, wherein
the second information is obtained by using a unique protocol different from the IPP.

6. The storage medium according to claim 1, wherein
the first information is information which can be interpreted by an installed OS on the computer.

7. The storage medium according to claim 6, wherein
the second information is obtained by using Get-Printer-Attributes Request which is a printer attribute obtaining request of the IPP, but is information which cannot be interpreted by the OS.

8. The storage medium according to claim 1, wherein
the second information is information containing at least vendor-specific information of the printing apparatus.

9. The storage medium according to claim 8, wherein
the vendor-specific information contains information of at least one of an error number or a URL of a consumable purchase site.

10. The storage medium according to claim 1, wherein
the predetermined notification is a toast notification, and
the predetermined operation is a user operation on a toast displayed on the display device based on the toast notification.

11. An information processing apparatus connected to the printing apparatus, comprising:
one or more memories storing instructions; and
one or more processors executing the instructions to:
obtain first information from the printing apparatus in accordance with IPP (Internet Printing Protocol);
execute, based on the obtained first information, a predetermined notification relating to the printing apparatus;
obtain second information from the printing apparatus in accordance with a predetermined operation performed on the predetermined notification, the second information containing at least information which is not contained in the first information; and
cause, based on the obtained second information, a display device to display information on the printing apparatus, the information on the printing apparatus corresponding to a type of the printing apparatus.

12. A method for controlling an information processing apparatus connected to a printing apparatus, the method comprising causing a computer to execute the following processing:
obtaining first information from the printing apparatus in accordance with IPP (Internet Printing Protocol);
executing, based on the obtained first information, a predetermined notification relating to the printing apparatus;
obtaining second information from the printing apparatus in accordance with a predetermined operation performed on the predetermined notification, the second information containing at least information which is not contained in the first information; and
causing, based on the obtained second information, a display device to display information on the printing apparatus, the information on the printing apparatus corresponding to a type of the printing apparatus.
